(19) United States
(12) Patent Application Publication
(10) Pub. No.: US 2026/0086476 A1
(43) Pub. Date: Mar. 26, 2026

(54) IMAGE FORMING APPARATUS WITH SEAL MEMBER

(71) Applicant: CANON KABUSHIKI KAISHA, Tokyo (JP)

(72) Inventor: TSUKASA ABE, Kanagawa (JP)

(21) Appl. No.: 19/405,125

(22) Filed: Dec. 1, 2025

Related U.S. Application Data
(63) Continuation of application No. 18/173,686, filed on Feb. 23, 2023, now abandoned.

(30) Foreign Application Priority Data
Feb. 28, 2022 (JP) 2022-028900

(51) Int. Cl. G03G 15/08

(52) U.S. Cl. CPC G03G 15/0886

(57) ABSTRACT

An image forming apparatus includes an apparatus main body, and a toner container configured to take a mounted state and a dismounted state, and including a supply port, wherein the apparatus main body includes a reception port and a seal member, the reception port is configured to receive the toner supplied from the toner container and communicate with the supply port in the mounted state, and the seal member is disposed around the reception port and configured to seal a gap between the toner container and the apparatus main body in the mounted state, and wherein the seal member includes a foam layer and an elastic sheet fixed to a surface of the foam layer, and the seal member is partially pressed in the mounted state so that the elastic sheet deflects in the thickness direction.

### CROSS-REFERENCE TO RELATED APPLICATIONS

The present application is a continuation of U.S. Patent Application No. 18/173,686, filed on Feb. 23, 2023, which claims priority from Japanese Patent Application No. 2022-028900, filed Feb. 28, 2022, which are hereby incorporated by reference herein in their entireties.

### BACKGROUND

### Field of Disclosure

The present disclosure relates to an image forming apparatus.

### Description of the Related Art

There is known an electrophotographic image forming apparatus having a configuration in which a toner cartridge accommodating toner can be detachably mounted on an apparatus main body. The toner cartridge supplies the toner to a process cartridge via a toner conveyance device of the apparatus main body. The toner conveyance device has a reception port for receiving the toner supplied from the toner cartridge. A seal member for preventing toner leakage through a gap between the toner cartridge and the toner conveyance device in mounting and dismounting the toner cartridge is disposed near the reception port (Japanese Patent Application Laid-Open No. 2021-081511).

### SUMMARY

According to an aspect of the present disclosure, an image forming apparatus includes an apparatus main body, and a toner container configured to take a mounted state where the toner container is mounted to the apparatus main body and is to supply toner to the apparatus main body and a dismounted state where the toner container is dismounted from the apparatus main body, and including a supply port through which the toner is to be supplied to the apparatus main body, wherein the apparatus main body includes a reception port and a seal member, the reception port is configured to receive the toner supplied from the toner container and communicate with the supply port in the mounted state, and the seal member is disposed around the reception port and configured to seal a gap between the toner container and the apparatus main body in the mounted state, and wherein the seal member includes a foam layer and an elastic sheet fixed to a surface of the foam layer on a side of the toner container in a thickness direction of the seal member, and the seal member is partially pressed in the mounted state so that the elastic sheet deflects in the thickness direction.

Further features of the present disclosure will become apparent from the following description of embodiments with reference to the attached drawings.

### BRIEF DESCRIPTION OF THE DRAWINGS

FIG. 1 is a sectional view of an image forming apparatus according to a first embodiment.

FIG. 2 is a perspective view of a toner conveyance device according to the first embodiment.

FIGS. 3A to 3D are front views and sectional views near a container shutter of a toner container according to the first embodiment.

FIG. 4 is a sectional view of the toner conveyance device according to the first embodiment.

FIG. 5 is a sectional view near a reception port of the toner conveyance device according to the first embodiment.

FIG. 6 is a perspective view of a toner conveyance device according to a second embodiment.

FIG. 7 is a sectional view of the toner conveyance device according to the second embodiment.

FIG. 8 is a sectional view near a reception port of the toner conveyance device according to the second embodiment.

### DESCRIPTION OF THE EMBODIMENTS

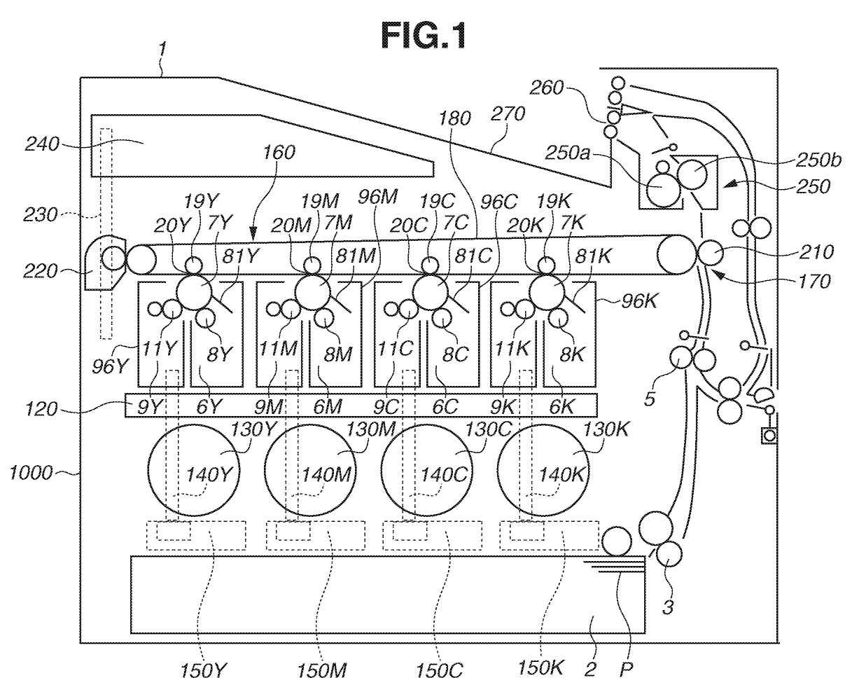

A first embodiment according to the present disclosure will be described. FIG. 1 illustrates a main cross section of an image forming apparatus 1. The image forming apparatus 1 includes process cartridges 96 and an apparatus main body 1000 on which the process cartridges 96 can be detachably mounted.

The process cartridges 96 include four color process cartridges 96Y, 96M, 96C, and 96K for yellow, magenta, cyan, and black, respectively. The process cartridges 96 (96Y, 96M, 96C and 96K) include respective photosensitive drums 7 (7Y, 7M, 7C and 7K), charging rollers 8 (8Y, 8M, 8C and 8K), developing units 9 (9Y, 9M, 9C and 9K), and cleaning blades 81 (81Y, 81M, 81C and 81K).

The developing units 9 include respective developing rollers 11. The developing rollers 11 supply toner to electrostatic latent images that are formed on the photosensitive drums 7 by laser emitted from a laser scanner unit 120 based on image information. Toner images are thereby developed on the photosensitive drums 7.

The toner images on the photosensitive drums 7 are transferred to an intermediate transfer belt 180 at primary transfer portions 20 (20Y, 20M, 20 C and 20K). The toner images of the respective colors are consecutively transferred to form a four-color toner image on the surface of the intermediate transfer belt 180. This toner image is conveyed to a secondary transfer portion 170 by the intermediate transfer belt 180.

Corresponding toner containers 130 (130Y, 130M, 130C and 130K) are located under the process cartridges 96 of the respective colors. The toner containers 130 contain respective color toners, with which toner conveyance devices 140 replenish the developing units 9 (process cartridges 96) of the respective colors depending on toner consumption in the developing units 9 of the respective colors. For the sake of toner replenishment by the toner conveyance devices 140 (140Y, 140M, 140C and 140K), the toner conveyance devices 140 are driven by toner conveyance driving devices 150 (150Y, 150M, 150C and 150K) located under the toner conveyance devices 140.

A cassette 2 containing recording materials P is disposed in a lower part of the image forming apparatus 1. The recording materials P are conveyed to a conveyance roller 5 one by one by rotation of a sheet feed roller 3.

An intermediate transfer unit 160 is located above the developing units 9. The intermediate transfer belt 180 opposed to the photosensitive drums 7 of the respective colors is a rotatable endless belt and stretched on a plurality of stretching rollers. Primary transfer rollers 19 (19Y, 19M, 19C and 19K) serving as primary transfer members are disposed on the inner surface of the intermediate transfer belt 180 at positions where the primary transfer rollers 19 (19Y, 19M, 19C and 19K) form the primary transfer portions 20 (20Y, 20M, 20C and 20K) of the respective colors with the photosensitive drums 7 of the respective colors via the intermediate transfer belt 180. At the primary transfer portions 20 of the respective colors, the primary transfer rollers 19 to which a voltage is applied transfer the toner images from the respective photosensitive drums 7 to the intermediate transfer belt 180.

A secondary transfer roller 210 is in contact with the intermediate transfer belt 180 and forms the secondary transfer portion 170 with a counter roller via the intermediate transfer belt 180. At the secondary transfer portion 170, the toner image transferred to the intermediate transfer belt 180 is secondarily transferred to the recording material P. Toner remaining on the intermediate transfer belt 180 without being transferred to the recording material P is removed by a cleaning unit 220. The toner removed by the cleaning unit 220 is conveyed to a toner collection container 240 via a toner conveyance unit 230 and stored in the toner collection container 240.

The recording material P to which the unfixed toner image is transferred is conveyed downstream of the secondary transfer portion 170, and pressed and heated by a heating unit 250a and a pressure roller 250b of a fixing device 250.

The toner image is thereby fixed to the recording material P. The recording material P is then discharged to a sheet discharge tray 270 by a discharge roller pair 260. Image formation on the recording material P is performed by such a series of operations.

### Toner Conveyance Device

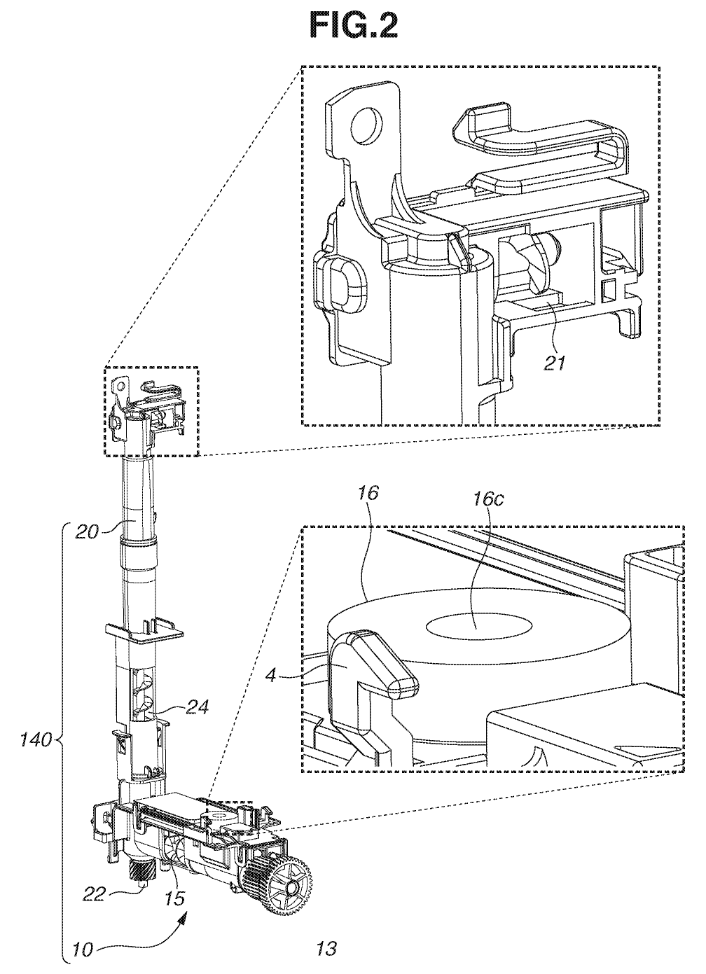

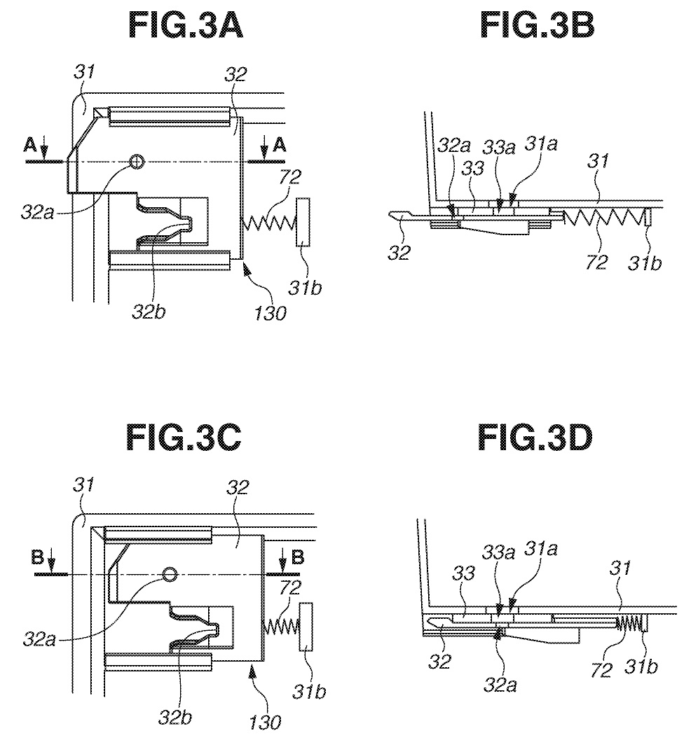

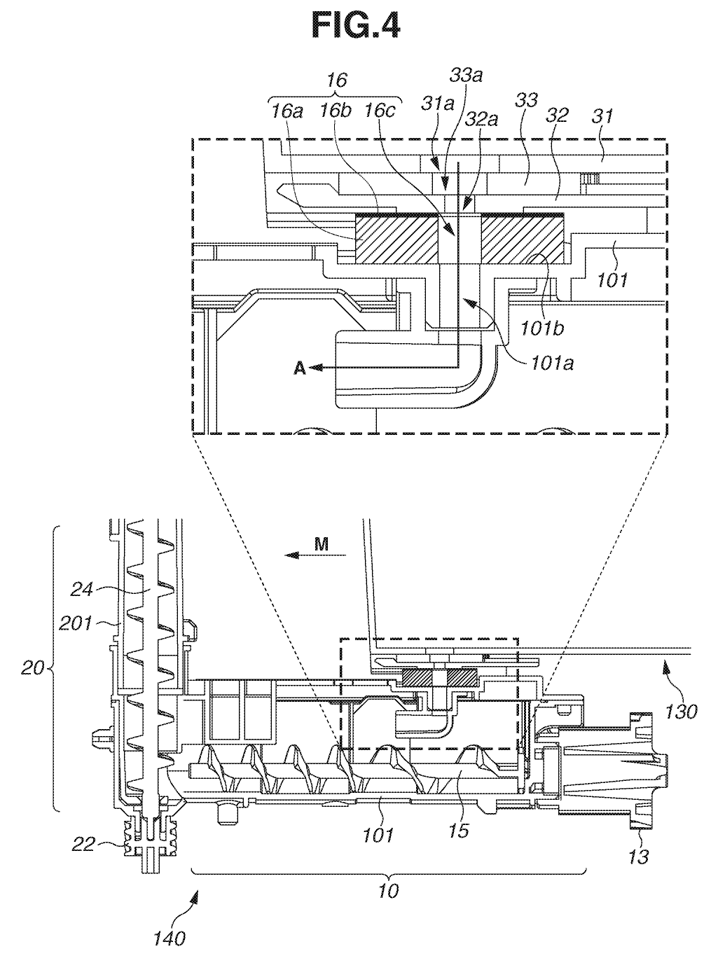

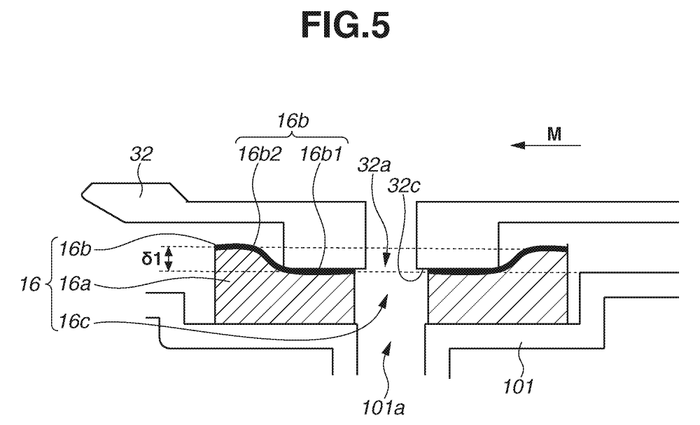

A configuration of the toner conveyance devices 140 included in the image forming apparatus 1 will be described with reference to FIGS. 2 to 5. FIG. 2 is a perspective view of a toner conveyance device 140. FIGS. 3A to 3D are diagrams illustrating a configuration of a container shutter 32 of a toner container 130. FIG. 4 is a sectional view of the toner conveyance device 140. FIG. 5 is an enlarged sectional view near an elastic seal member (hereinafter, referred to simply as a seal member) 16 of the toner conveyance device 140.

In FIG. 2, some structures are omitted to illustrate an internal configuration of the toner conveyance device 140.

As illustrated in FIG. 2, the toner conveyance device 140 includes an upstream conveyance unit 10 and a downstream conveyance unit 20.

As illustrated in FIG. 4, the upstream conveyance unit 10 includes an upstream frame 101 and an upstream conveyance screw 15. The upstream frame 101 has a reception port 101a in its top surface and forms a conveyance space. The upstream conveyance screw 15 is disposed inside the upstream frame 101. The upstream conveyance screw 15 is driven to rotate by an upstream drive gear 13, and conveys toner received through the reception port 101a toward the downstream conveyance unit 20.

The downstream conveyance unit 20 includes a downstream frame 201 forming a conveyance space, and a downstream conveyance screw 24 disposed inside the downstream frame 201. An upstream end of the downstream frame 201 in the conveyance direction of the toner is connected to a downstream end of the upstream frame 101.

The downstream conveyance screw 24 is driven to rotate by a downstream drive gear 22, and conveys the toner conveyed from the upstream conveyance unit 10 toward the developing unit 9 of the process cartridge 96 above. The developing unit 9 illustrated in FIG. 1 is replenished with the toner conveyed upward by the downstream conveyance screw 24 via a discharge port 21 illustrated in FIG. 2.

### Container Shutter of Toner Container

FIG. 3A is a view of the toner container 130 dismounted from the toner conveyance device 140, i.e., in a dismounted state, seen from the side of the container shutter 32. FIG. 3B is a sectional view taken along line A-A of FIG. 3A. FIG. 3C is a view of the toner container 130 mounted on the toner conveyance device 140, i.e., in a mounted state, seen from the side of the container shutter 32. FIG. 3D is a sectional view taken along line B-B of FIG. 3C.

The toner container 130 includes an accommodation frame 31 accommodating the toner, a supply port 31a formed in the accommodation frame 31, and the container shutter 32 that opens and closes the supply port 31a. The container shutter 32 includes a shutter opening 32a and a pressed portion 32b.

The container shutter 32 can move relative to the accommodation frame 31, between a closed position where the container shutter 32 closes the supply port 31a and an open position where the container shutter 32 opens the supply port 31a. The container shutter 32 is biased in a direction of shifting from the open position to the closed position by a compression spring 72 (elastic member, biasing member). One end of the compression spring 72 is engaged with an engagement portion 31b of the accommodation frame 31. The other end of the compression spring 72 is in contact (engaged) with the container shutter 32. If the toner container 130 is in the dismounted state, the container shutter 32 is at the closed position while being biased by the compression spring 72 as illustrated in FIGS. 3A and 3B. If the toner container 130 is in the mounted state, the container shutter 32 is at the open position as illustrated in FIGS. 3C and 3D. In the process of mounting the toner container 130 on the toner conveyance device 140, the pressed portion 32b (recess) of the container shutter 32 is pressed by a pressing portion 4 (protrusion) (FIG. 2) of the toner conveyance device 140, whereby the container shutter 32 is moved from the closed position to the open position against the biasing force of the compression spring 72.

As illustrated in FIG. 3B, when the container shutter 32 is at the closed position, the shutter opening 32a does not communicate with the supply port 31a of the accommodation frame 31. As illustrated in FIG. 3D, when the container shutter 32 is at the open position, the shutter opening 32a communicates with the supply port 31a of the accommodation frame 31. The toner container 130 includes a container seal 33 having a seal hole 33a communicating with the supply port 31a. The container seal 33 seals a gap between the accommodation frame 31 and the container shutter 32.

With the toner container 130 in the mounted state, the supply port 31a, the seal hole 33a, and the shutter opening 32a communicate with each other, through which the toner in the accommodation frame 31 of the toner container 130 is supplied into the upstream frame 101 of the toner conveyance device 140.

### Seal Member

As illustrated in FIG. 4, a seal member 16 is attached (fixed) to a top surface (outer surface) 101b of the upstream frame 101 around the reception port 101a. The seal member 16 is configured to seal a gap between the toner container 130 and the upstream frame 101 when the toner container 130 is in the mounted state, so that the toner supplied in the direction of the arrow A will not leak.

The seal member 16 includes a foam layer 16a (foam, elastic member) and an elastic sheet 16b disposed on the surface of the foam layer 16a. The seal member 16 has an opening 16c through both the foam layer 16a and the elastic sheet 16b. The opening 16c is intended for the toner to pass through. The foam layer 16a is an open-cell polyurethane layer having a thickness of 6 mm when not compressed. The elastic sheet 16b is a 50-μm-thick polyethylene terephthalate (PET) sheet.

The foam layer 16a may be any low-resilience elastic layer and does not need to be a foam layer. A polycarbonate (PC) or polyphenylene sulfide (PPS) sheet may be used as the elastic sheet 16b. The elastic sheet 16b desirably has a thickness of 25 μm or more and not more than 75 μm.

As illustrated in FIG. 5, when the toner container 130 is in the mounted state, the seal member 16 is partially pressed and compressed by a protrusion 32c of the container shutter 32. The shutter opening 32a of the container shutter 32 is formed in the protrusion 32c.

The elastic sheet 16b includes a contact area 16b1 with which the protrusion 32c of the container shutter 32 configured to be in contact and a noncontact area 16b2 with which the container shutter 32 configured to be not in contact. With the toner container 130 in the mounted state, the contact area 16b1 of the elastic sheet 16b is compressed by δ1 mm compared to the noncontact area 16b2. In other words, when the toner container 130 is in the mounted state, at least a part of the noncontact area 16b2 of the elastic sheet 16b is located closer to the container shutter 32 (toner container 130) than the contact area 16b1 is. As described above, the seal member 16 is configured so that the elastic sheet 16b deflects (deforms elastically) in a thickness direction when the toner container 130 is in the mounted state.

If the toner container 130 is shifted from the mounted state to the dismounted state, the compressed seal member 16 restores its original shape. Here, the restoring force caused by the deflection (elastic deformation) of the elastic sheet 16b acts on the foam layer 16a in a direction where the foam layer 16a restores its original shape (direction in which the compressed state is released). As a result, the seal member 16 restores the original shape (decompressed) faster than without the elastic sheet 16b. This, for example, increases the possibility that the seal member 16 has already restored the original shape when the toner container 130 is dismounted for replacement and a new toner container 130 is mounted. The sealability of the seal member 16 can thereby be improved.

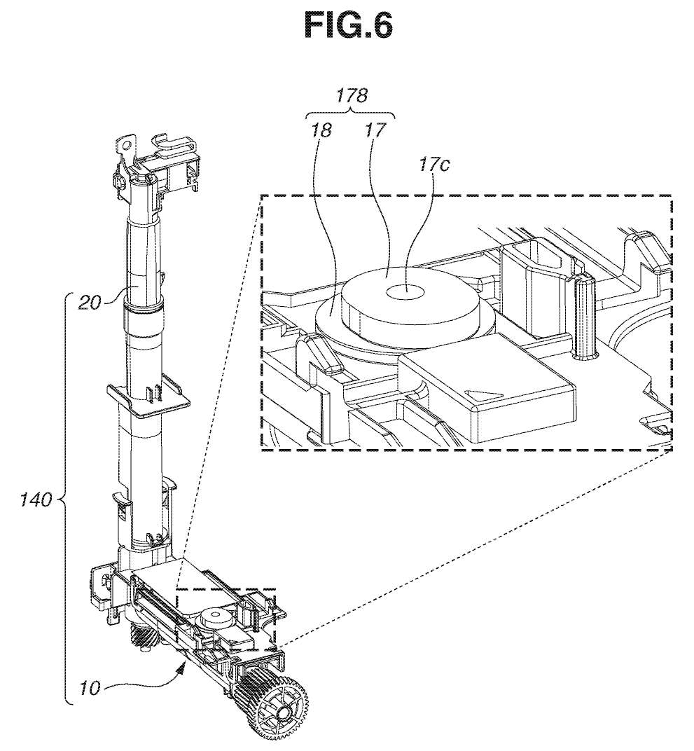

A configuration of a second embodiment of the present disclosure will be described with reference to FIGS. 6 to 8. In the second embodiment, a seal member of a toner conveyance device 140 and a container shutter of a toner container 130 are different in shape from those of the first embodiment. Similar elements to those of the first embodiment are denoted by the same reference numerals, and a description thereof will be omitted. The container shutter 322 includes a shutter opening 322a.

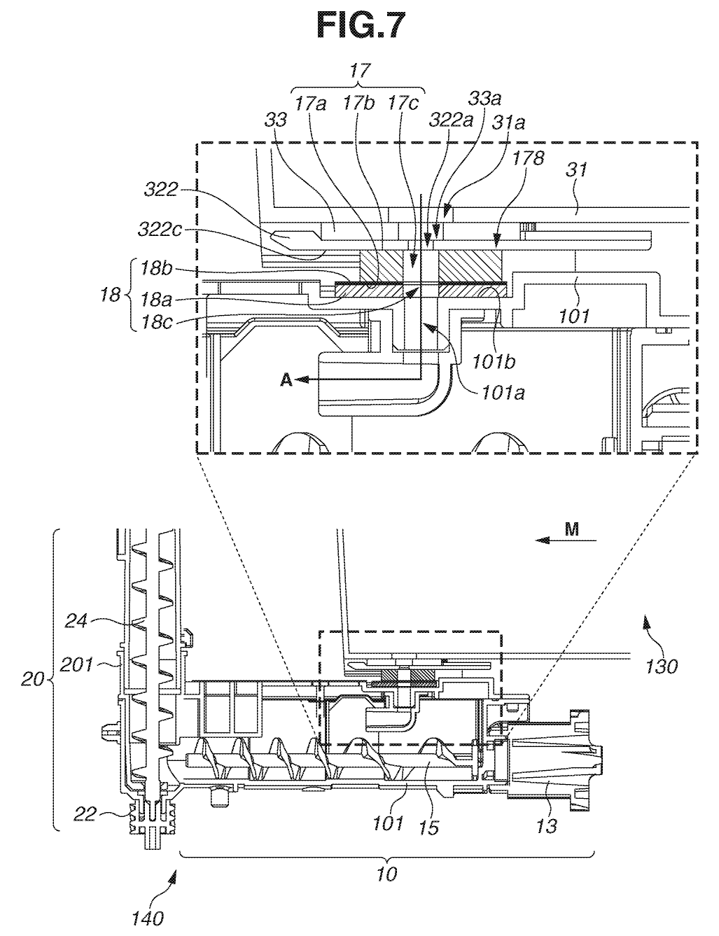

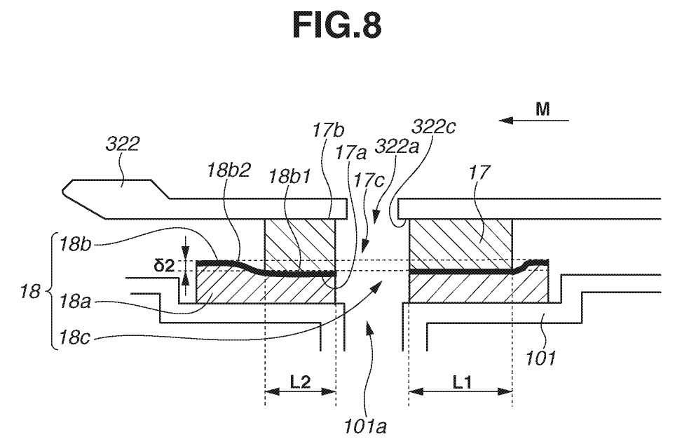

FIG. 6 is a perspective view of the toner conveyance device 140. FIG. 7 is a sectional view of the toner conveyance device 140. FIG. 8 is an enlarged sectional view near a multilayer seal member 178 of the toner conveyance device 140.

As illustrated in FIG. 7, the multilayer seal member 178 is attached to the top surface (outer surface) 101b of the upstream frame 101 around the reception port 101a. The multilayer seal member 178 is configured to seal a gap between the toner container 130 and the upstream frame 101 when the toner container 130 is in the mounted state, so that the toner supplied in the direction of the arrow A will not leak through the gap.

### Multilayer Seal Member

A configuration of the multilayer seal member 178 will be described. As illustrated in FIGS. 6 and 7, the multilayer seal member 178 includes a first seal member 18 and a second seal member 17 disposed on the first seal member 18. With the toner container 130 in the mounted state, both the first and second seal members 18 and 17 are compressed in the thickness direction. The first seal member 18 has lower hardness than that of the second seal member 17. The first seal member 18 is thus configured to be compressed by a greater amount than the amount of compression of the second seal member 17. When the multilayer seal member 178 is seen in the thickness direction thereof, the first seal member 18 has a greater area than that of the second seal member 17.

Like the seal member 16 according to the first embodiment, the first seal member 18 includes a foam layer 18a (foam, elastic layer) and an elastic sheet 18b disposed on the surface of the foam layer 18a. One surface of the foam layer 18a is attached to the top surface 101b of the upstream frame 101. The elastic sheet 18b is fixed to the other surface of the foam layer 18a. The foam layer 18a is an open-cell polyurethane layer having a thickness of 3 mm when not compressed. The elastic sheet 18b is a 50-μm-thick PET sheet. A PC or PPS sheet may be used as the elastic sheet 18b. The elastic sheet 18b desirably has a thickness of 25 μm or more and 75 μm or less.

The second seal member 17 is a closed-cell foam (foam, elastic body, rubber layer) consisting mainly of chloroprene rubber. The second seal member 17 has higher hardness than that of the first seal member 18. A first surface 17a (bottom surface) of the second seal member 17 in the thickness direction is in contact with a contact area 18b1 that is a part of the elastic sheet 18b of the first seal member 18. The surface of the first seal member 18 opposed to the second seal member 17 includes, aside from the contact area 18b1, a noncontact area 18b2 not in contact with the first surface 17a of the second seal member 17.

With the toner container 130 in the mounted state, the second seal member 17 presses the contact area 18b1 of the first seal member 18 downward. A second surface 17b (top surface) of the second seal member 17 opposite the first surface 17a is configured to be in contact with a contact surface 322c of a container shutter 322 when the toner container 130 is in the mounted state.

With the toner container 130 in the mounted state, the contact area 18b1 of the elastic sheet 18b is compressed by δ2 mm compared to the noncontact area 18b2. In other words, when the toner container 130 is in the mounted state, at least a part of the noncontact area 18b2 of the elastic sheet 18b is located closer to the container shutter 322 (toner container 130) than the contact area 18b1 is. As described above, the multilayer seal member 178 is configured so that the elastic sheet 18b of the first seal member 18 deflects (deforms elastically) in the thickness direction when the toner container 130 is in the mounted state.

If the toner container 130 is shifted from the mounted state to the dismounted state, the compressed multilayer seal member 178 restores its original shape. Here, the restoring force caused by the deflection (elastic deformation) of the elastic sheet 18b of the first seal member 18 acts on the foam layer 18a in the direction where the foam layer 18a restores its original shape (direction in which the compressed state is released). As a result, the multilayer seal member 178 (first seal member 18) restores the original shape (decompressed) faster than without the elastic sheet 18b. This, for example, increases the possibility that the multilayer seal member 178 has restored the original shape at timing when the toner container 130 is dismounted for replacement and a new toner container 130 is mounted. The sealability of the multilayer seal member 178 can thereby be improved.

In the present embodiment, the second seal member 17 partially presses the first seal member 18 including the elastic sheet 18b. The contact surface 322c of the container shutter 322 can thus be in contact with the entire second surface 17b of the second seal member 17. Unlike the protrusion 32c of the container shutter 32 according to the first embodiment, the contact surface 322c of the container shutter 322 can therefore be configured as a flat surface. This reduces the possibility of the toner container 130 gets caught on the multilayer seal member 178 in the process of mounting the toner container 130 in a configuration where the toner container 130 is moved and mounted on the toner conveyance device 140 in the mounting direction M (see FIGS. 4, 5, 7, and 8).

As illustrated in FIG. 8, in the mounting direction M, the length L1 of the second seal member 17 upstream of a through hole 17c is greater than the length L2 of the second seal member 17 downstream the through hole 17c. This makes the second surface 17b of the second seal member 17 less likely to deform due to the force (shearing force) in the mounting direction M from the contact surface 322c of the container shutter 322 when the toner container 130 is moved and mounted in the mounting direction M.

In the first and second embodiments, the mounting direction M of the toner container 130 with respect to the toner conveyance device 140 is a direction along the top surface 101b of the upstream frame 101 (direction intersecting the thickness direction of the seal member). However, this is not restrictive. The effects of the first and second embodiments can be obtained even if the mounting direction of the toner container 130 is a direction intersecting the top surface 101b (thickness direction of the seal member).

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

What is claimed is:

1. An image forming apparatus comprising:
an apparatus main body; and
a toner container configured to take a mounted state where the toner container is mounted to the apparatus main body and is to supply toner to the apparatus main body and a dismounted state where the toner container is dismounted from the apparatus main body, the toner container including a supply port through which the toner is to be supplied to the apparatus main body,
wherein the apparatus main body includes a frame having a surface on which a reception port is provided and to which a seal member is fixed, the reception port being configured to receive the toner supplied from the toner container and to communicate with the supply port in the mounted state, the seal member being disposed around the reception port and being configured to seal a gap between the toner container and the surface of the frame in the mounted state, and
wherein the seal member includes a foam layer having an inner surface fixed to the surface of the frame and an outer surface opposite to the inner surface in a thickness direction of the seal member, and an elastic sheet covering the outer surface of the foam layer,
wherein in the mounted state, a surface of the elastic sheet on a side of the toner container includes a pressed area where the elastic sheet is pressed by mounting of the toner container to the apparatus main body and a non-pressed area where the elastic sheet is not pressed by the mounting of the toner container, and
wherein in the mounted state, a thickness of the seal member in the non-pressed area of the elastic sheet is greater than a thickness of the seal member in the pressed area in the thickness direction.

2. The image forming apparatus according to claim 1,
wherein the toner container includes a shutter configured to open and close the supply port, and
wherein in the mounted state, the pressed area of the elastic sheet is a contact area of the elastic sheet with which the shutter of the toner container is in contact, and the non-pressed area of the elastic sheet is a non-contact area of the elastic sheet with which the shutter of the toner container is not in contact.

3. The image forming apparatus according to claim 1,
wherein in a case where the seal member is a first seal member, the apparatus main body includes a second seal member having a first surface and a second surface which are opposed to each other in the thickness direction and which are in contact with the elastic sheet of the first seal member and the toner container, respectively, in the mounted state, and
wherein in the mounted state, the pressed area of the elastic sheet is a contact area of the elastic sheet with which the first surface of the second seal member is in contact, and the non-pressed area of the elastic sheet is a non-contact area of the elastic sheet with which the first surface of the second seal member is not in contact.

4. The image forming apparatus according to claim 3,
wherein the toner container includes a container shutter configured to move between an open position where the container shutter opens the supply port and a closed position where the container shutter closes the supply port, and
wherein in the mounted state, the container shutter is in contact with the second surface of the second seal member.

5. The image forming apparatus according to claim 4, wherein in the mounted state, the container shutter is in contact with an entire area of the second surface of the second seal member.

6. The image forming apparatus according to claim 1, wherein the elastic sheet is made of any one of polyethylene terephthalate, polycarbonate, and polyphenylene sulfide.

7. The image forming apparatus according to claim 1, wherein the elastic sheet has a thickness of 25 μm or more and 75 μm or less.

8. The image forming apparatus according to claim 1, wherein a mounting direction of the toner container with respect to the apparatus main body is a direction intersecting the thickness direction.
